(19) United States
(12) Patent Application Publication
(10) Pub. No.: US 2024/0404176 A1
(43) Pub. Date: Dec. 5, 2024

(54) SORT-TOP RASTERIZATION AND TILE RENDERING USING AN ACCELERATION STRUCTURE

(71) Applicant: ADVANCED MICRO DEVICES, INC., Santa Clara, CA (US)

(72) Inventor: Christopher J. Brennan, Boxborough, MA (US)

(21) Appl. No.: 18/205,407

(22) Filed: Jun. 2, 2023

(51) Int. Cl. G06T 15/20; G06T 1/20; G06T 17/20

(52) U.S. Cl. CPC G06T 15/20; G06T 1/20; G06T 17/20

(57) ABSTRACT

To render a scene in a display space, a processor is configured to perform sort-top tiled rendering. To this end, the processor is configured to divide a display space into two or more tiles and assign each tile to a respective graphics core of the processor. Further, the processor is configured to divide a viewport of the scene into corresponding frustums each representing a portion of the viewport in a respective tile. Using a corresponding frustum associated with an assigned tile, each graphics core performs one or more frustum queries to determine one or more graphics objects in a tile to rasterize, one or more draw calls to perform for a tile, or both.

### BACKGROUND

To render a scene using tiled rendering, processing systems first divide a screen space into tiles and assign each tile to a rasterization engine of a graphics processing unit (GPU). Further, to determine which graphics objects of the scene within each tile to rasterize, some processing systems perform sort-middle rasterization. To this end, some processing systems include geometry engines together configured to compute the positions of the vertices of each primitive in a scene to be rendered and, based on the positions of the vertices, determine geometry data for the primitives. After the geometry engines determine such geometry data, the processing systems then redistribute the determined geometry data from the geometry engines to respective rasterization engines. As an example, a processing system redistributes geometry data associated with a first primitive to a rasterization engine assigned to a tile including the first primitive. Using received geometry data, each rasterization engine determines which graphics objects within a respective tile to rasterize. In this way, the geometry data is passed from the graphics engines to respective rasterization engines so that each rasterization engine can determine which graphics objects to rasterize within a respective tile. However, passing the geometry data from the graphics engines to the rasterization engines in this way increases the resources needed to rasterize the graphics objects in the scene and increases the processing time needed to render the scene.

### BRIEF DESCRIPTION OF THE DRAWINGS

The present disclosure may be better understood, and its numerous features and advantages are made apparent to those skilled in the art by referencing the accompanying drawings. The use of the same reference symbols in different drawings indicates similar or identical items.

FIG. 1 is a block diagram of a processing system 100 configured to perform sort-top rasterization and tiled rendering, in accordance with some embodiments.

FIG. 2 is a block diagram of an example accelerated processing unit (APU) including one or more graphics cores configured to perform one or more frustum queries, in accordance with some embodiments.

FIG. 3 is a diagram of an example acceleration structure used for one or more frustum queries, in accordance with some embodiments.

FIG. 4 is a flow diagram of an example operation for performing sort-top rasterization, in accordance with some embodiments.

FIG. 5 is a flow diagram of an example operation for tiled rendering by a graphics core, in accordance with some embodiments.

FIG. 6 is a flow diagram illustrating an example method for sort-top rasterization, in accordance with some embodiments.

### DETAILED DESCRIPTION

To render a scene including one or more graphics objects (e.g., sets of primitives) in a screen space (e.g., display space), some processing systems are configured to first divide a screen space into two or more tiles each including a first number of pixels in a first (e.g., vertical) direction and a second number of pixels in a second (e.g., horizontal) direction. For each tile of the screen space, a processor (e.g., accelerated processing unit (APU), graphics processing unit (GPU)) of such processing systems assigns a respective rasterization engine of a GPU to a tile. Such rasterization engines, for example, include hardware-based circuitry, software-based circuitry, or both configured to perform rasterization, rendering, or both for one or more graphics objects of the scene within a tile assigned to the rasterization engine. To determine which graphics objects within a tile a rasterization engine is to rasterize, the processor is configured to perform sort-middle rasterization which includes one or more geometry engines of a processor each computing vertex data for respective primitives of the scene to be entered. Such geometry engines, for example, include hardware-based circuitry, software-based circuitry, or both configured to compute vertex data for a primitive that indicates the positions of the vertices of the primitive in the scene to be rendered. Based on the determined vertex data for one or more respective primitives, each geometry engine performs one or more shader operations to determine geometry data indicating a position of the respective primitives in the scene to be rendered. After determining such geometry data, each geometry engine then provides the vertex data, geometry data, or both associated with a primitive to a respective rasterization engine assigned to the screen space that includes the primitive.

Using the received vertex data, geometry data, or both, each rasterization engine then determines one or more graphics objects within a respective tile to rasterize by, for example, determining the position of graphics objects, primitives, or both within the respective tile. In this way, the geometry engines of a processor first calculate vertex data, geometry data, or both for the primitives of the scene before redistributing the vertex data, geometry data, or both for the primitives to respective rasterization engines. Additionally, some processing systems include each rasterization engine independently calculating geometry data for the graphics objects in the scene to be rendered and determining one or more graphics objects, primitives, or both to render based on the determined geometry data. However, passing vertex data, geometry data, or both between the geometry engines and rasterization engines increases the processing resources and processing time needed to rasterize the graphics objects, primitives, or both in each tile, decreasing the processing efficiency of the processing system. Likewise, having each rasterization engine independently calculate geometry data for the graphics objects to determine which graphics objects to rasterize also increases the processing resources and processing time needed to rasterize the graphics objects, primitives, or both in each tile.

To this end, systems and methods disclosed herein are directed to performing sort-top rendering and tiled rendering. For example, a processing system includes an APU including one or more graphics cores each assigned to a tile of a screen space (e.g., a tile of a display space). Each graphics core, for example, includes hardware-based circuitry, software-based circuitry, or both configured to rasterize one or more graphics objects in an assigned tile. To rasterize one or more graphics objects of a scene to be rendered in an assigned tile, a graphics core is configured to perform one or more frustum queries on an acceleration structure indicating the graphics objects of the scene to be rendered. Such an acceleration structure includes, for example, a data structure including one or more levels of nodes representing hierarchically arranged bounding boxes, bounding volumes, or both that each encompasses one or more graphics objects, portions of one or more graphics objects (e.g., meshlets), or both within the scene to be rendered in the screen space (e.g., display space). As an example, an acceleration structure includes a bounding volume hierarchy (BVH) representing two or more hierarchically arranged bounding volumes that each encompass graphics objects, portions of graphics objects, or both of the scene to be rendered. As another example, such an acceleration structure includes one or more data structures derived from, modified from, or built from one or more acceleration structures associated with a ray tracing operation (e.g., acceleration structures built for ray tracing operations, acceleration structures used in ray tracing operations). To perform a frustum query, a graphics core assigned to a tile is configured to determine whether one or more graphics objects as represented by one or more nodes of an acceleration structure are wholly within a frustum associated with a tile, at least partially within a frustum associated with the tile, intersects a plane of a frustum associated with the tile, or any combination thereof. These frustums, for example, each represent a respective view within a scene to be rendered in a respective tile and include data indicating two or more planes defining an unbounded shape (e.g., rectangular pyramid, triangular pyramid) in the scene in the tile, a viewpoint within the scene in the tile, or both.

Based on the frustum query, the graphics core assigned to a tile generates a list of graphics objects that indicates the graphics objects that were wholly within the frustum of the tile, at least partially within the frustum of the tile, intersecting a plane of the frustum of the tile, or any combination thereof. Using the list of graphics objects, the graphics core assigned to a tile then determines one or more graphics objects to rasterize. For example, the graphics core rasterizes each graphics object indicated in the list of graphics objects. In this way, each graphics core is configured to rasterize and render graphics objects for a tile independent of other graphics cores rendering graphics objects for other tiles. For example, each graphics core is configured to rasterize and render graphics objects without needing data (e.g., vertex data, geometry data) from one or more other graphics cores, decreasing the processing time needed to render the scene and increasing the processing efficiency of the processing system.

To render one or more graphics objects, portions of graphics objects (e.g., meshlets), or both in a tile, a graphics core assigned to the tile is configured to determine one or more draw calls to perform. To this end, the graphics core assigned to the tile performs one or more frustum queries on an acceleration structure including one or more nodes representing portions of graphics objects (e.g., meshlets) of the scene to be rendered. For example, the graphics core assigned to the tile determines whether one or more portions of graphics objects as represented by one or more nodes of an acceleration structure are wholly within the frustum of the tile, at least partially within the frustum of the tile, intersect a plane of the frustum of the tile, or any combination thereof. Based on the frustum query, the graphics core assigned to a tile generates a list of portions of graphics objects representing each portion of a graphics object wholly within the frustum of the tile, at least partially within the frustum of the tile, intersect a plane of the frustum of the tile, or any combination thereof. Using the list of portions of graphics objects, the graphics core assigned to a tile determines one or more draw calls. As an example, the graphics core assigned to a tile determines one or more draw calls for each portion of a graphics object indicated in the list of portions of graphics objects. After determining the draw calls, the graphics core places one or more of the draw calls in a buffer, performs one or more of the draw calls, or both. In this way, each graphics core is configured to render portions of graphics objects in a tile independently of the other graphics cores because no vertex or geometry data is shared between the graphics cores. Additionally, each graphics core is enabled to render graphics objects that are different from the graphics objects being rendered by one or more other graphics cores, decreasing the time needed to render the scene and increasing processing efficiency.

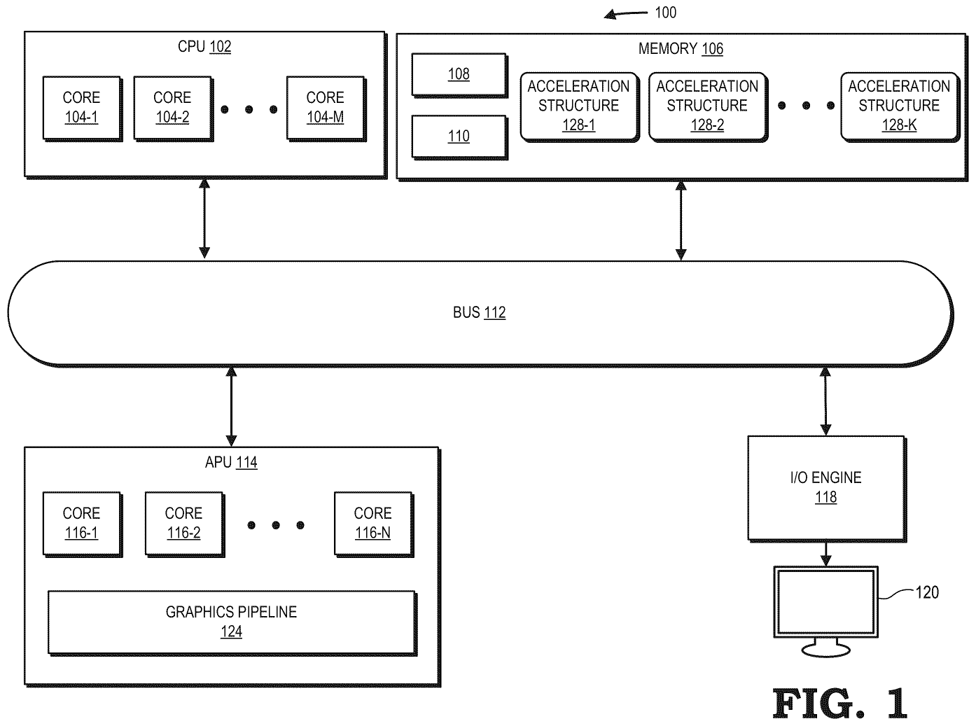

FIG. 1 is a processing system 100 configured to perform sort-top rasterization and tiled rendering using one or more acceleration structures, according to embodiments. To this end, the processing system 100 includes or has access to a memory 106 or other storage component implemented using a non-transitory computer-readable medium, for example, a dynamic random-access memory (DRAM). However, in implementations, the memory 106 is implemented using other types of memory including, for example, static random-access memory (SRAM), nonvolatile RAM, and the like. According to implementations, the memory 106 includes an external memory implemented external to the processing units implemented in the processing system 100. The processing system 100 also includes a bus 112 to support communication between entities implemented in the processing system 100, such as the memory 106. Some implementations of the processing system 100 include other buses, bridges, switches, routers, and the like, which are not shown in FIG. 1 in the interest of clarity.

The techniques described herein are, in different implementations, employed at accelerated processing unit (APU) 114. APU 114 includes, for example, vector processors, coprocessors, graphics processing units (GPUs), general-purpose GPUs (GPGPUs), non-scalar processors, highly parallel processors, artificial intelligence (AI) processors, inference engines, machine learning processors, other multithreaded processing units, scalar processors, serial processors, or any combination thereof. The APU 114 renders scenes within a screen space (e.g., the space in which a scene is displayed) according to one or more applications 110 for presentation on a display 120. For example, the APU 114 renders graphics objects (e.g., sets of primitives) of a scene in a screen space (e.g., display space) to be displayed to produce values of pixels that are provided to the display 120, which uses the pixel values to display a scene that represents the rendered graphics objects. To render these graphics objects, the APU 114 implements a plurality of processor cores 116-1 to 116-N that execute instructions concurrently or in parallel. For example, the APU 114 executes instructions from one or more graphics pipelines 124 using a plurality of processor cores 116 to render one or more graphics objects. A graphics pipeline 124 includes, for example, one or more steps, stages, or instructions to be performed by APU 114 in order to render one or more graphics objects for a scene. As an example, a graphics pipeline 124 includes data indicating an assembler stage, vertex shader stage, hull shader stage, tessellator stage, domain shader stage, geometry shader stage, binner stage, rasterizer stage, pixel shader stage, output merger stage, or any combination thereof to be performed by one or more processor cores 116 of APU 114 in order to render one or more graphics objects for a scene.

In embodiments, one or more processor cores 116 of APU 114 each operate as a compute unit configured to perform one or more operations for one or more instructions received by APU 114. These compute units each include one or more single instruction, multiple data (SIMD) units that perform the same operation on different data sets to produce one or more results. For example, APU 114 includes one or more processor cores 116 each functioning as a compute unit that includes one or more SIMD units to perform operations for one or more instructions from a graphics pipeline 124. To facilitate one or compute units performing operations for instructions from a graphics pipeline 124, APU 114 includes one or more command processors (not shown for clarity). Such command processors, for example, include hardware-based circuitry, software-based circuitry, or both configured to execute one or more instructions from a graphics pipeline 124 by providing data indicating one or more operations, operands, instructions, variables, register files, or any combination thereof to one or more compute units necessary for, helpful for, or aiding in the performance of one or more operations for the instructions. Though the example implementation illustrated in FIG. 1 presents APU 114 as having three processor cores (116-1, 116-2, 116-N) representing an N number of cores, the number of processor cores 116 implemented in the APU 114 is a matter of design choice. As such, in other implementations, the APU 114 can include any number of processor cores 116. Some implementations of the APU 114 are used for general-purpose computing. For example, the APU 114 executes instructions such as program code 108 for one or more applications 110 stored in the memory 106 and the APU 114 stores information in the memory 106 such as the results of the executed instructions.

In some embodiments, APU 114 is configured to divide a screen space (e.g., display space) into two or more tiles and render each tile individually by performing, for example, sort-top tiled rendering. That is to say, for each tile of a screen space, APU 114 is configured to determine which graphics objects are in the tile and then render the graphics objects determined to be in the tile using sort-top tiled rendering. According to embodiments, each tile of a screen space has a first number of pixels in a first (e.g., vertical) direction and a second number of pixels in a second (e.g., horizontal) direction. To perform sort-top tiled rendering, APU 114 includes one or more graphics cores (not shown for clarity) each assigned to a respective tile of the screen space and configured to rasterize one or more graphics objects within an assigned tile, render one or more graphics objects within an assigned tile, or both. For example, a graphics core includes one or more processor cores 116 of APU 114 each configured to operate as a compute unit configured to perform one or more operations for instructions of a graphics pipeline 124 to rasterize one or more graphics objects in a tile, render one or more graphics objects in a tile, or both. To facilitate the performance of such operations for instructions of a graphics pipeline 124, each graphics core of APU 114 is associated with (e.g., communicatively coupled to) a respective command processor of APU 114 configured to provide data (e.g., operations, operands, instructions, variables, register files) to one or more compute units of a graphics core necessary for, helpful for, or aiding in the performance of the operations for a respective set of instructions. Because each graphics core is associated with a respective command processor configured to provide data based on a respective set of instructions, the graphics cores are enabled to render different graphics objects at different times. That is to say, two or more graphics cores are configured to concurrently render different graphics objects such that, for example, a first graphics core renders a first graphics object and a second graphics core concurrently renders a second graphics object different from the first graphics object.

According to embodiments, to rasterize and render one or more graphics objects in a tile using sort-top tiled rendering, each graphics core of APU 114 is configured to determine which graphics objects, portions of graphics objects (e.g., meshlets), or both are within a respective tile assigned to the graphics core based on one or more acceleration structures 128, stored for example, in memory 106, a cache included in or otherwise connected to APU 114, or both. Such acceleration structures 128, for example, each include levels of nodes representing hierarchically arranged bounding boxes, bounding volumes, or both that each encompasses one or more graphics objects (e.g., sets of triangles or other primitives), portions of one or more graphics objects (e.g., meshlets), or both within a scene to be rendered in a screen space. As an example, an acceleration structure 128 includes a bounding volume hierarchy (BVH) representing two or more hierarchically arranged bounding volumes that each encompass graphics objects, portions of graphics objects, or both of a scene to be rendered within a screen space. As another example, an acceleration structure 128 includes a first level of hierarchy that includes nodes indicating bounding volumes encompassing graphics objects (e.g., sets of triangles or other primitives) and a second level of hierarchy that includes nodes indicating portions of the graphics objects (e.g., meshlets) wherein the second level of hierarchy is a lower level than the first level of hierarchy. Though the example embodiment in FIG. 1 presents memory 106 as including three acceleration structures (128-1, 128-2, 128-K) representing a K number of acceleration structures, in other embodiments, memory 106, a cache included in or otherwise connected to APU 114, or both can include any number of acceleration structures 128.

To determine which graphics objects, portions of graphics objects, or both are within a respective tile based on an acceleration structure 128, a graphics core is configured to perform one or more frustrum queries on one or more nodes of an acceleration structure 128. A frustum query, for example, includes a graphics core determining whether one or more graphics objects, portions of graphics objects, or both as represented by one or more nodes of an acceleration structure 128 are wholly within a frustum, are at least partially within a frustum, intersect with a plane of a frustum, or any combination thereof. That is to say, as an example, a frustum query indicates a position of at least a portion of the graphics object relative to the frustum. For example, a frustum query includes a graphics core determining whether one or more graphics objects as represented by one or more nodes of the same level of hierarchy in an acceleration structure 128 are at least partially within a frustum. The frustums used in these frustum queries, for example, each represent a respective view within a scene to be rendered in a tile and include data indicating two or more planes defining an unbounded shape (e.g., rectangular pyramid, triangular pyramid) in the scene in a tile, a viewpoint within a scene in a tile, or both. According to embodiments, APU 114 is configured to generate and assign a corresponding frustum for each tile of a screen space (e.g., display space) such that each graphics core of the APU 114 is configured to use a corresponding frustum associated with a respective tile to perform one or more frustum queries. For example, in some embodiments, APU 114 receives data (e.g., from a graphics driver) indicating, for example, a viewport of the scene (e.g., data indicating a position, angle, distance, or any combination thereof from which the scene is viewed). Based on the viewport, APU 114 then generates a corresponding frustum for each tile of the screen space. As an example, for each tile of a screen space (e.g., display space), APU 114 generates a respective frustum representing the corresponding portion of the viewport within that tile.

Based on a frustum query using a respective frustum representing the corresponding portion of the viewport within that tile, each graphics core is configured to generate data indicating the one or more graphics objects, portions of graphics objects (e.g. meshlets), or both of the acceleration structure 128 that are wholly within the respective frustum of a tile, at least partially within the respective frustum, intersect with a plane of the respective frustum, or any combination thereof. As an example, based on a frustum query of an acceleration structure 128, a graphics core is configured to generate a list of graphics objects that are wholly within a respective frustum of a tile. As another example, based on a frustum query of an acceleration structure 128, a graphics core is configured to generate a list of portions of graphics objects that are at least partially within a corresponding frustum of a tile (e.g., a frustum representing the corresponding portion of the viewport within that tile). Using the data indicating the graphics objects, portions of graphics objects, or both that are wholly within, at least partially within, or intersect a plane of a corresponding frustum, a graphics core is configured to rasterize one or more graphics objects within a tile, determine draw calls for one or more graphics objects within a tile, or both. For example, based on a list of graphics objects at least partially within a frustum, a graphics core is configured to rasterize each graphics object indicated in the list of graphics objects. As another example, based on a list of portions of graphics objects (e.g., meshlets) determined to be at least partially within a frustum, a graphics core is configured to place draw calls in a buffer, perform draw calls, or both for each portion of a graphics object indicated in the list of portions of graphics objects. In this way, each graphics core is configured to rasterize and render graphics objects for a tile independent of other graphics cores rendering graphics objects for other tiles. For example, each graphics core is configured to rasterize and render graphics objects without needing data (e.g., vertex data, geometry data) from one or more other graphics cores such that a first graphics core is configured to render a first graphics object and a second graphics core is configured to concurrently render a second graphics object that is different from the first graphics object. As such, unlike a sort-middle architecture, because each graphics core is configured to rasterize and render graphics objects without needing data from one or more other graphics cores, no data is shared between the graphics cores, decreasing the time needed to render the scene.

According to some embodiments, one or more graphics cores of APU 114 are configured to provide the data generated from a frustum query to a shader node of a graphics pipeline 124. Such a shader node, for example, includes instructions for processing, culling, sorting, or any combination thereof graphical objects. As an example, based on a frustum query of an acceleration structure 128, a graphics core is configured to generate a list of the portions of graphics objects (e.g., meshlets) that are at least partially within a frustum of a tile and provide the list to a shader node of a graphics pipeline 124. In response to receiving the list of portions of graphics objects, the shader node is configured to process, cull, sort, or any combination thereof the portions of graphics objects indicated in the list to produce a processed list of portions of graphics objects. After receiving the processed list of portions of graphical objects from the shader node, a graphics core is configured to place draw calls in a buffer, perform draw calls, or both for each portion of a graphics object indicated in the processed list of portions of graphical objects.

The processing system 100 also includes a central processing unit (CPU) 102 that is connected to the bus 112 and therefore communicates with the APU 114 and the memory 106 via the bus 112. The CPU 102 implements a plurality of processor cores 104-1 to 104-N that execute instructions concurrently or in parallel. In implementations, one or more of the processor cores 104 operate as SIMD units that perform the same operation on different data sets. For example, one or more processor cores 104 operate as SIMD units each having two or more lanes each configured to perform an operation (e.g., spatial test) of a wave. Though in the example implementation illustrated in FIG. 1, three processor cores (104-1, 104-2, 104-M) are presented representing an M number of cores, the number of processor cores 104 implemented in the CPU 102 is a matter of design choice. As such, in other implementations, the CPU 102 can include any number of processor cores 104. In some implementations, the CPU 102 and APU 114 have an equal number of processor cores 104, 116 while in other implementations, the CPU 102 and APU 114 have a different number of processor cores 104, 116. The processor cores 104 execute instructions such as program code 108 for one or more applications 110 stored in the memory 106 and the CPU 102 stores information in the memory 106 such as the results of the executed instructions. The CPU 102 is also able to initiate graphics processing by issuing draw calls to the APU 114.

Processing system 100 also includes an input/output (I/O) engine 118 that includes hardware and software to handle input or output operations associated with the display 120, as well as other elements of the processing system 100 such as keyboards, mice, printers, external disks, and the like. The I/O engine 118 is coupled to the bus 112 so that the I/O engine 118 communicates with the memory 106, the APU 114, or the CPU 102.

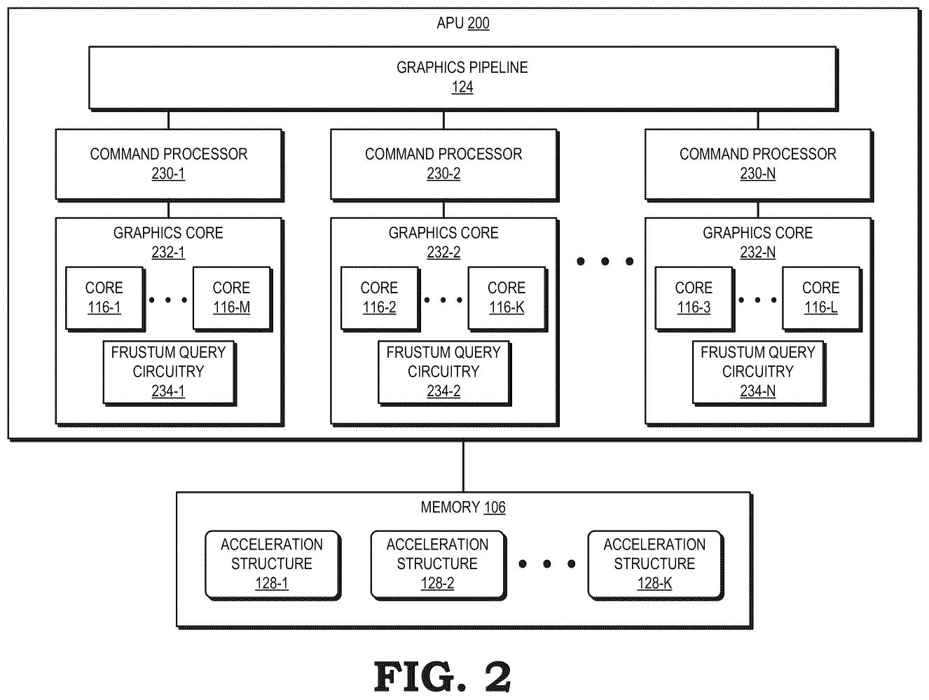

Referring now to FIG. 2, an example APU including one or more graphics cores configured to perform one or more frustum queries is presented. According to embodiments, APU 200, similar to or the same as APU 114, includes one or more command processors 230 each associated with (e.g., connected to) a respective graphics core 232 and including hardware-based circuitry, software-based circuitry, or both configured to manage and execute instructions from a graphics pipeline 124. For example, to execute one or more instructions from graphics pipeline 124, each command processor 230 is configured to provide data to a respective graphics core 232 configured to perform operations for the instructions. Such data, for example, includes one or more operations, operands, instructions, variables, register files, or any combination thereof necessary for, helpful for, or aiding in the performance of one or more operations for instructions from graphics pipeline 124. Because each command processor 230 executes instructions by providing data to a respective graphics core 232, each command processor 230 is configured to execute a respective set of instructions that differ from a set of instructions executed by one or more other command processors 230. As such, the command processors 230 are configured to concurrently execute instructions for rasterizing and rendering different graphics objects. For example, a first command processor 230-1 is configured to execute a first set of instructions to render a first graphics objects by providing a first set of data to a first graphics core 232-1 and a second command processor 230-2 is configured to execute a second set of instructions to render a second graphics object that is different from the first graphics object by providing a second set of data to a second graphics core 232-2. Though the example embodiment presents APU 200 as having three command processors (230-1, 230-2, 230-N) representing an N number of command processors each associated with a respective graphics core (232-1, 232-2, 232-N), in other embodiments, APU 200 can have any number of command processors 230 each associated with a respective graphics core 232.

Each graphics core 232 is configured to perform one or more operations for one or more instructions from graphics pipeline 124 based on data (e.g., data indicating one or more operations, operands, instructions, variables, register files, or any combination thereof) provided by a respective command processor 230. In embodiments, APU 200 is configured to assign a respective tile of a screen space (e.g., the space in which one or more scenes are to be rendered) to each graphics core 232 such that each graphics core 232 is assigned to a different tile. After being assigned a respective tile, each graphics core 232 is configured to rasterize and render one or more graphics objects in the tile. For example, a graphics core 232 is configured to perform one or more operations to rasterize and render one or more graphics objects in a tile. To perform such operations, each graphics core 232 includes one or more processor cores 116 each functioning as a compute unit (e.g., a unit including one or more SIMD units that perform the same operation on different data sets to produce one or more results). Though the example embodiment presented in FIG. 2 shows each graphics core (232-1, 232-2, 232-N) as having two processor cores (e.g., 116-1, 116-M, 116-2, 116-K, 116-3, 116-L) each representing an M, K, and L number of processor cores, respectively, in other embodiments, each graphics core 232 can include any number of processor cores 116 each functioning as compute units.

According to embodiments, each graphics core 232 is configured to perform sort-top rasterization to rasterize, render, or both one or more graphics objects within a tile. Such sort-top rasterization, for example, includes one or more graphics cores 232 concurrently determining which graphics objects in respective tiles to rasterize without first computing the vertices of the graphics objects. To this end, in embodiments, APU 200 is first configured to receive a viewport of a scene to be rendered that indicates, for example, a position, angle, distance, or any combination thereof from which the scene to be rendered is viewed. As an example, APU 200 receives a rasterization state from a graphics driver that indicates a viewport of a scene to be rendered. Based on the viewport, APU 200 then generates one or more respective frustums for each tile of the screen space (e.g., display space). For example, for each tile, APU 200 generates a frustum that represents the respective portion of the viewport in the tile. Such frustums each represent a respective view within at least a portion of a scene to be rendered in a tile and include data indicating two or more planes defining an unbounded shape (e.g., rectangular pyramid, triangular pyramid) in at least a portion of scene to be rendered in a tile, a viewpoint within at least a portion of a scene to be rendered in a tile, or both.

In embodiments, to facilitate sort-top rasterization, each graphics core 232 is configured to perform one or more frustum queries on one or more acceleration structures 128 that each include, for example, levels of nodes representing hierarchically arranged bounding boxes, bounding volumes, or both that each encompasses one or more graphics objects (e.g., sets of triangles or other primitives) within a scene to be rendered, portions of graphics objects (e.g., meshlets) within the scene to be rendered, or both. To perform frustum queries, each graphics core 232 includes respective frustum query circuitry (234-1, 234-2, 234-N) that includes hardware-based circuitry, software-based circuitry, or both configured to perform frustrum queries on one or more acceleration structures 128 (e.g., on one or more levels of nodes in an acceleration structure 128). To perform a frustum query, frustum query circuitry 234 is configured to determine if one or more graphics objects, portions of graphics objects, or both as represented by a level of nodes in an acceleration structure 128 are wholly within a frustum, at least partially within a frustum, intersecting a plane of a frustum, or any combination thereof. As an example, to perform a frustum query for a tile assigned to a graphics core 232, the frustum query circuitry 234 of the graphics core 232 is configured to determine whether one or more graphics objects as represented by a first level of nodes in an acceleration structure 128 are wholly within a frustum associated with the tile, at least partially within a frustum associated with the tile, intersecting a plane of a frustum associated with the tile, or any combination thereof.

Based on a frustum query, frustum query circuitry 234 is configured to generate data indicating which graphics objects, portions of graphics objects (e.g., meshlets), or in one or more bounding volumes of an acceleration structure 128 are wholly within a frustum of a tile, at least partially within a frustum of a tile, intersecting a plane of a frustum of a tile, or any combination thereof. As an example, based on a frustum query, frustum query circuitry 234 is configured to generate a list of graphics objects, portions of graphics objects, or both that are wholly with a frustum of a tile, at least partially within a frustum of a tile, intersecting a plane of a frustum of a tile, or any combination thereof.

According to embodiments, during sort-top rasterization, one or more graphics cores 232 are configured to determine which graphics objects to rasterize within a tile. For example, two or more graphics cores 232 concurrently determine which graphics objects to rasterize within respective tiles assigned to the graphics cores 232. To this end, a graphics core 232 (e.g., frustum query circuitry 234) assigned to a tile is configured to perform a frustum query using the corresponding frustum associated with the tile to determine which graphics objects as represented by a first level of nodes of an acceleration structure 128 are wholly within the frustum, at least partially within the frustum, intersecting a plane of the frustum, or any combination thereof. Based on the frustum query, the graphics core 232 then generates a list of graphics objects wholly within the frustum, at least partially within the frustum, intersecting a plane of the frustum, or any combination thereof. Using this list of graphics objects, the graphics core 232 then performs rasterization for the graphics objects indicated in the list of graphics objects to produce pixel values. In this way, two or more graphics cores 232 are configured to concurrently perform rasterization for graphics objects in respective tiles without first determining the vertex values of the graphics objects. Additionally, each graphics core 232 is configured to perform rasterization without needing vertex information, geometry information, or both to be shared from one or more other graphics cores, reducing the amount of data shared between the graphics cores 232 and decreasing the processing time needed to perform rasterization for a scene.

Further, in embodiments, during sort-top rasterization, one or more graphics cores 232 are configured to determine draw calls for portions of graphics objects within a tile. For example, two or more graphics cores 232 concurrently determine draw calls for portions of graphics objects within respective tiles assigned to the graphics cores 232. To this end, a graphics core 232 (e.g., frustum query circuitry 234) assigned to a tile is configured to perform a frustum query using the frustum associated with the tile to determine which portions of graphics objects (e.g., meshlets) as represented by a second level of nodes in acceleration structure 128 are wholly within the frustum, at least partially within the frustum, intersecting a plane of the frustum, or any combination thereof. That is to say, such a frustum query, as an example, indicates a position of at least a portion of the graphics object relative to the frustum. Based on the frustum query, the graphics core 232 then generates a list of portions of graphics objects wholly within the frustum, at least partially within the frustum, intersecting a plane of the frustum, or any combination thereof. Using this list of portions of graphics objects, the graphics core 232 then places draw calls in a buffer, performs draw calls, or both for the portions of graphics objects indicated in the list of portions of graphics objects to render the portions of graphics objects in the tile assigned to the graphics core 232. According to embodiments, a graphics core 232 is configured to provide a generated list of portions of graphics objects to a shader node of a graphics pipeline 124 including instructions for processing, culling, sorting, or any combination thereof graphical objects. In response to receiving the list of portions of graphics objects, the shader node is configured to process, cull, sort, or any combination thereof the list of portions of graphics objects to produce a processed list of portions of graphics objects. Based on the processed list of portions of graphical objects, the graphics core 232 is configured to place draw calls in a buffer, perform draw calls, or both for each portion of a graphics object (e.g., meshlet) indicated in the processed list of portions of graphical objects.

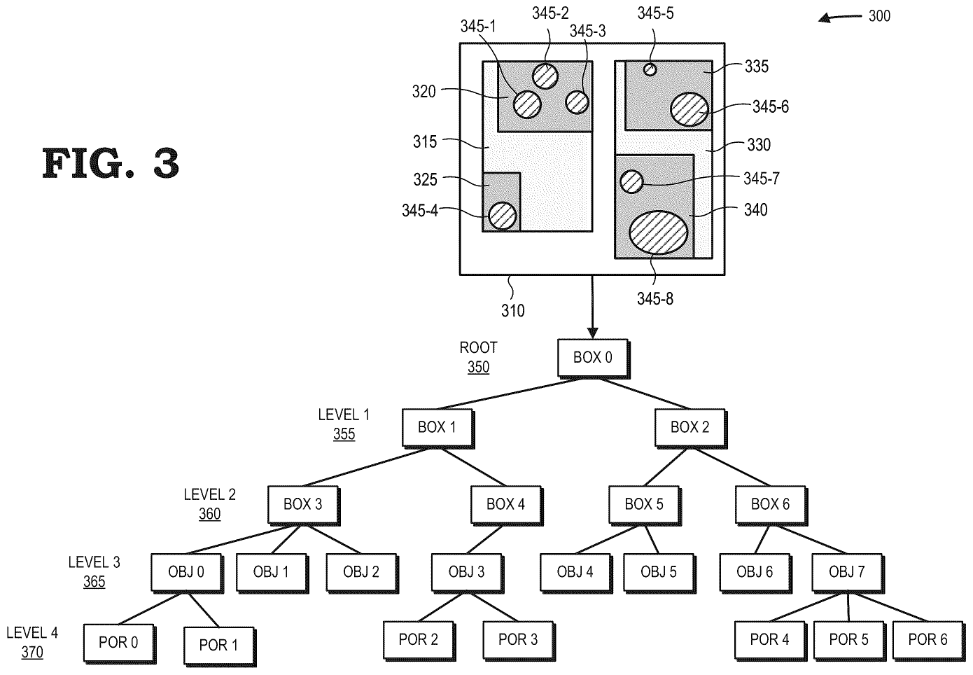

Referring now to FIG. 3, a diagram of an example acceleration structure used for one or more frustum queries is presented. In embodiments, example acceleration structure 300, similar to or the same as acceleration structures 128, includes data representing one or more graphics objects 345 of a scene to be rendered in screen space 310 (e.g., a display space). As an example, acceleration structure 300 includes levels of nodes representing hierarchically arranged bounding boxes, bounding volumes, or both that each encompasses one or more graphics objects 345, portions of one or more graphics objects (e.g., meshlets), or both within the scene to be rendered in a screen space 310. Such graphics objects 345, for example, each include data representing a set of primitives within a scene. Though the example embodiment of FIG. 3 presents the scene in screen space 310 as having eight graphics objects (345-1, 345-2, 345-3, 345-4, 345-5, 345-6, 345-7, 345-8), in other embodiments, the scene in screen space 310 can have any number of graphics objects 345.

According to embodiments, to represent one or more graphics objects 345 of a scene to be rendered in screen space 310, acceleration structure 300 includes a data structure having two or more hierarchical levels that each include a number of nodes. As an example, acceleration structure 300 includes a first hierarchical level (e.g., root 350) that includes a single node (e.g., Box 0) that represents all the graphics objects (345-1, 345-2, 345-3, 345-4, 345-5, 345-6, 345-7, 345-8) in screen space 310. Further, acceleration structure 300 includes a second level (e.g., level 1 355) that includes a first node (e.g., Box 1) and a second node (e.g., Box 2) each connected to the node (e.g., Box 0) of the first hierarchical level. The nodes of the second level (e.g., level 1 355) together represent a first set of bounding boxes 315, 330 in screen space 310 encompassing the graphics objects 345. For example, a first node (e.g., Box 1) of the second hierarchical level (e.g., level 1 355) represents a first bounding box 315 encompassing the graphics objects 345-1, 345-2, 345-3, 345-4 and a second node (e.g., Box 2) of the second hierarchical level represents a second bounding box 330 encompassing the graphics objects 345-5, 345-6, 345-7, 345-8. In embodiments, acceleration structure 300 also includes a third hierarchical level (e.g., level 2 360) that includes a first node (e.g., Box 3), second node (e.g., Box 4), third node (e.g., Box 5), and a fourth node (e.g., Box 6) each connected to respective nodes of the second hierarchical level. The nodes of the third level (e.g., level 2 360) together represent a second set of bounding boxes 320, 325, 335, 340 in screen space 310 encompassing the graphics objects 345. For example, a first node (e.g., Box 3) of the third hierarchical level (e.g., level 2 360) represents a third bounding box 320 encompassing the graphics objects 345-1, 345-2, 345-3, a second node (e.g., Box 4) of the third hierarchical level represents a fourth bounding box 325 encompassing graphics object 345-4, a third node (e.g., Box 5) of the third hierarchical level represents a fifth bounding box 335 encompassing the graphics objects 345-5, 345-6, and a fourth node (e.g., Box 6) of the third hierarchical level represents a sixth bounding box 340 encompassing the graphics objects 345-7, 345-8.

Additionally, according to embodiments, acceleration structure 300 includes a fourth hierarchical level (e.g., level 3 365) that includes nodes each connected to a respective node of the third hierarchical level. For example, the fourth hierarchical level (e.g., level 3 365) includes a first node (e.g., OBJ 0) representing graphics object 345-1, a second node (e.g., OBJ 1) representing graphics object 345-2, a third node (e.g., OBJ 2) representing graphics object 345-3, a fourth node (e.g., OBJ 3) representing graphics object 345-4, a fifth node (e.g., OBJ 4) representing graphics object 345-5, a sixth node (e.g., OBJ 5) representing graphics object 345-6, a seventh node (e.g., OBJ 6) representing graphics object 345-7, and an eighth node (e.g., OBJ 7) representing graphics object 345-8. Further, in some embodiments, acceleration structure 300 includes a fifth hierarchical level (e.g., level 4 370) that includes nodes (e.g., sub-nodes) each representing a respective portion (e.g., meshlet) of a graphics object 345 represented by a node of the fourth hierarchical level (e.g., level 3 365). As an example, a first node (e.g., POR 0) of the fifth hierarchical level (e.g., level 4 370) represents a first portion (e.g., meshlet) of graphics object 345-1, a second node (e.g., POR 1) of the fifth hierarchical level represents a second portion of graphics object 345-1 different from the first portion of graphics object 345-1, a third node (e.g., POR 2) of the fifth hierarchical level represents a first portion of graphics object 345-4, a fourth node (e.g., POR 3) of the fifth hierarchical level represents a second portion of graphics object 345-4 different from the first portion of graphics object 345-4, a fifth node (e.g., POR 4) of the fifth hierarchical level represents a first portion of graphics object 345-8, a sixth node (e.g., POR 5) of the fifth hierarchical level represents a second portion of graphics object 345-8 different from the first portion of graphics object 345-8, and a seventh node (e.g., POR 6) of the fifth hierarchical level represents a third portion of graphics object 345-8 different from the first and second portions of graphics object 345-8.

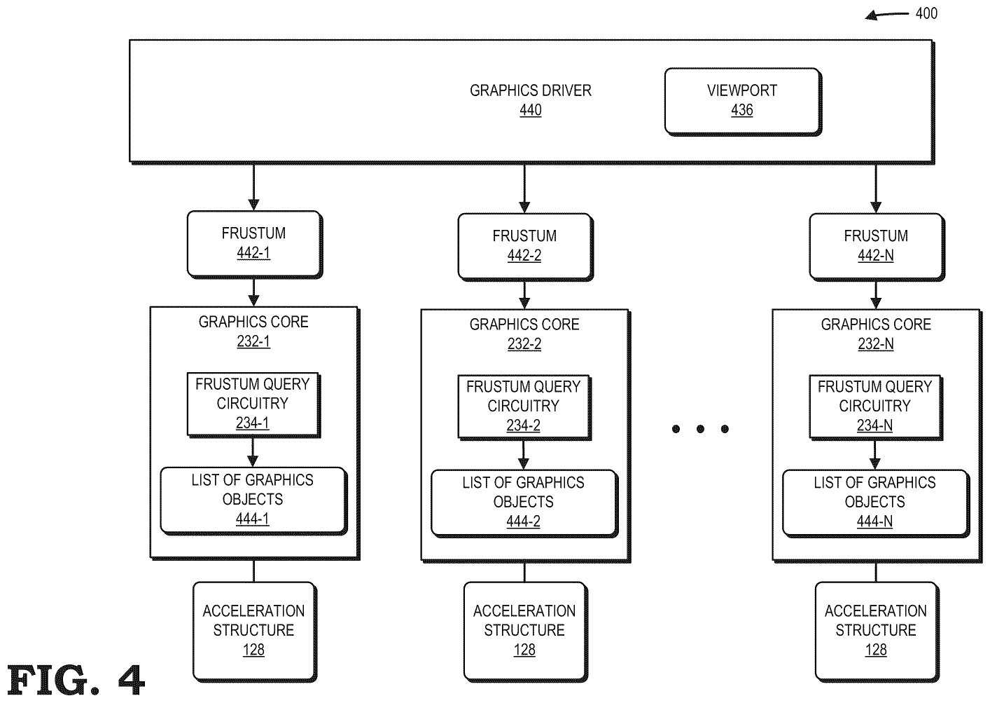

Referring now to FIG. 4, an example operation 400 for performing sort-top rasterization is presented. In embodiments, example operation 400 first includes a graphics driver 440 being executed by CPU 102, APU 114 (e.g., APU 200), or both. Such a graphics driver 440, for example, includes program code that, when executed, causes one or more instructions to be issued to perform one or more commands. According to embodiments, graphics driver 440 is first configured to (e.g., issue instructions to) divide a screen space (e.g., screen space 310) into two or more tiles each having a first number of pixels in a first direction (e.g., vertical direction) and a second number of pixels in a second direction (e.g., horizontal direction). After diving the screen space (e.g., display space) into two or more tiles, graphics driver 440 is configured to assign each tile to a respective graphics core 232. For example, graphics driver 440 assigns a first tile to a first graphics core 232-1, a second tile to a second graphics core 232-2, and a third tile to a third graphics core 232-N. Though the example embodiment in FIG. 4 presents example operation 400 as including three graphics cores 232 representing an N number of graphics cores 232 each assigned a respective tile, in other embodiments, example operation 400 can include any number of graphics cores 232 each assigned a respective tile.

Additionally, graphics driver 440 is configured to determine a viewport 436 for a scene to be rendered. For example, graphics driver 440 is configured to determine a rasterization state that indicates viewport 436 based on one or more user inputs. Viewport 436 includes, for example, data indicating a position, angle, distance, or any combination thereof from which a scene to be rendered is viewed. Based on viewport 436, graphics driver 440 is configured to generate a corresponding frustum 442 for each tile of the screen space. Each corresponding frustum 442, for example, represents a respective view within at least a portion of a scene to be rendered in a respective tile and includes data indicating two or more planes defining an unbounded shape (e.g., rectangular pyramid, triangular pyramid) in at least a portion of scene to be rendered in the tile, a viewpoint within at least a portion of a scene to be rendered in the tile, or both. As an example, for each tile in the screen space, graphics driver 440 generates a corresponding frustum 442 that represents the respective portion of viewport 436 within the tile. For example, a first frustum 442-1 represents a first portion of viewport 436 that is in a first tile, a second frustum 442-2 represents a second portion of viewport 436 that is in a second tile, and a third frustum 442-N represents a third portion viewport 436 that is in a third tile.

After the frustums 442 have been generated, each graphics core 232 assigned to a tile is configured to determine one or more graphics objects (e.g., graphics objects 345) to rasterize. To determine which graphics objects to rasterize, each graphics core 232 assigned to a tile is configured to perform a frustum query on an acceleration structure 128 using the corresponding frustum 442 associated with that tile (e.g., generated from the portion of viewport 436 in that tile). To this end, each graphics core 232 includes frustum query circuitry (234-1, 234-2, 234-N) configured to determine whether one or more objects as represented by one or more nodes of a hierarchical level of acceleration structure 128 (e.g., acceleration structure 300) are wholly within a respective frustum 442, at least partially within a respective frustum 442, intersect a plane of a respective frustum 442, or any combination thereof. For example, the frustum query circuitry 234 of a graphics core 232 is configured to determine whether one or more graphics objects as represented by the nodes of a hierarchical level (e.g., level 3 365) of an acceleration structure 128 are at least partially within a respective frustum 442. Based on a frustum query, frustum query circuitry 234 is configured to generate a respective list of graphics objects (444-1, 444-2, 444-N) that includes data indicating the graphics object in a scene to be rendered that are wholly within a frustum 442 of a tile (e.g., a frustum representing a view within that tile), at least partially within a frustum 442 of a tile, intersect a plane of a frustum 442 of a tile, or any combination thereof. Based on the respective list of graphics objects 444 generated by the frustum query circuitry 234 of a graphics core 232, the graphics core 232 is configured to determine one or more graphics objects to rasterize. For example, a first graphics core 232-1 is configured to rasterize each graphics object indicated in a respective list of graphics objects 444-1. By determining which graphics objects to rasterize by performing frustum queries on acceleration structures 128, each graphics core 232 is configured to perform rasterization without first determining vertex values for the graphics objects, reducing the processing resources and time needed to perform rasterization.

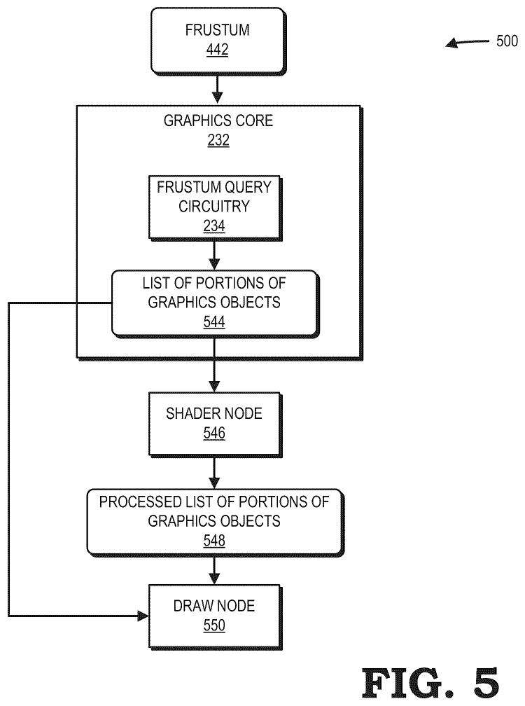

Referring now to FIG. 5, an example operation 500 for tiled rendering by a graphics core is presented. In embodiments, example operation 500 is configured to be performed subsequently or concurrently with example operation 400. According to embodiments, example operation 500 includes one or more graphics cores 232 each assigned to a respective tile of a screen space receiving a corresponding frustum 442 associated with the respective tile (e.g., generated from the portion of viewport 436 within that tile). Further, operation 500 includes one or more graphics cores 232 each assigned to a respective tile and each configured to determine one or more draw calls for rendering at least a portion of one or more graphics objects in a respective tile. To this end, each graphics core 232 assigned to a tile includes frustum query circuitry 234 configured to perform frustum queries on an acceleration structure 128 using a corresponding frustum 442 associated with the tile. For example, frustum query circuitry 234 is configured to determine which portions of graphical objects (e.g., meshlets) as represented by one or more nodes of a hierarchical level (e.g., level 4 370) of an acceleration structure 128 (e.g., acceleration structure 300) are wholly within a frustum 442 of a tile, at least partially within a frustum 442 of a tile, intersect with a plane of a frustum 442 of a tile, or any combination thereof.

Based on a frustum query, frustum query circuitry 234 is configured to generate a respective list of portions of graphics objects 544 that includes data indicating the portions of graphics object (e.g., meshlets) in a scene to be rendered that are wholly within a frustum 442 of a tile (e.g., a frustum representing a view within that tile), at least partially within a frustum 442 of a tile, intersect a plane of a frustum 442 of a tile, or any combination thereof. According to some embodiments, using the respective list of portions graphics objects 544 generated by the frustum query circuitry 234 of a graphics core 232, the graphics core 232 is configured to determine one or more draw calls for the tile. As an example, to determine one or more draw calls, the graphics core 232 provides the list of portions of graphics objects 544 to a draw node 550 of graphics pipeline 124. Such a draw node 550, for example, includes instructions for determining one or more draw calls for one or more portions of graphical objects (e.g., meshlets). For example, in response to receiving a list of portions of graphics objects 544, a draw node 550 is configured to determine draw calls for each portion of a graphics object indicated in the list of portions of graphics objects 544. After draw node 550 determines one or more draw calls, the graphics core 232 stores one or more of the draw calls in a buffer, performs one or more of the draw calls, or both.

As another example, to determine one or more draw calls for the tile, the graphics core 232 provides the list of portions of graphics objects 544 to a shader node 546 of graphics pipeline 124. Shader node 546, for example, includes instructions for processing, culling, sorting, or any combination thereof portions of graphical objects. In response to receiving the list of portions of graphics objects 544, the shader node 546 is configured to process, cull, sort, or any combination thereof the portions of graphics objects indicated in the received list of portions of graphics objects 544 to produce a processed list of portions of graphics objects 548. Shader node 546 then provides the processed list of portions of graphics objects 548 to draw node 550. From the processed list of portions of graphics objects 548, the draw node 550 determines one or more draw calls. For example, the draw node 550 is configured to determine draw calls for each portion of a graphics object indicated in the processed list of portions of graphics objects 548. After draw node 550 determines one or more draw calls, the graphics core 232 stores one or more of the draw calls in a buffer, performs one or more of the draw calls, or both. In this way, each graphics core 232 determines draw calls without data (e.g., vertex data, geometry data) being shared between the graphics cores 232. Because less data is shared between the graphics cores 232, the processing time and processing resources needed for the graphics cores 232 to render the tiles is reduced, improving the efficiency of the processing system.

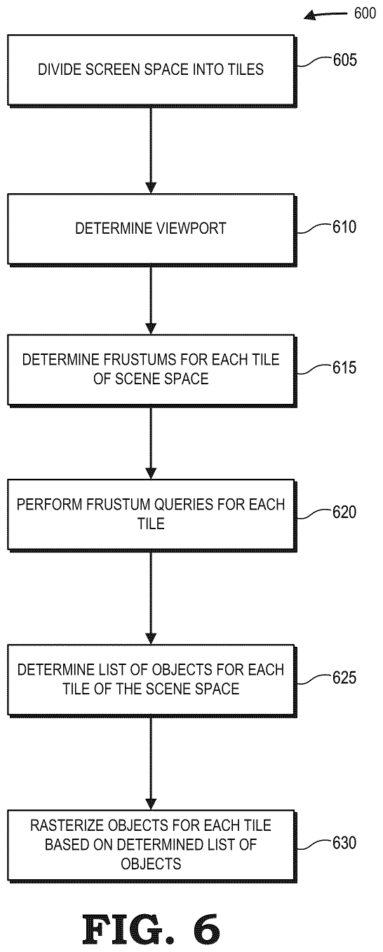

Referring now to FIG. 6, an example method 600 for sort-top rasterization is presented. In embodiments, at step 605 of method 600, graphics driver 440 divides a screen space (e.g., screen space 310) into two or more tiles each having a first number of pixels in a first direction (e.g., vertical direction) and a second number of pixels in a second direction (e.g., horizontal direction). Further, at step 605, graphics driver 440 assigns a respective graphics core 232 to each tile. At step 610, graphics driver 440 determines viewport 436. For example, based on one or more user inputs, graphics driver 440 determines a rasterization state that includes viewport 436. Viewport 436, for example, includes data indicating a position, angle, distance, or any combination thereof from which a scene to be rendered in the screen space (e.g., display space) is viewed. At step 615, graphics driver 440 determines a corresponding frustum 442 for each tile of the screen space based on viewport 436. For example, for each tile, graphics driver 440 generates a corresponding frustum 442 representing the respective portion of viewport 436 that is in the tile. Such frustums 442, for example, each include data indicating two or more planes defining an unbounded shape (e.g., rectangular pyramid, triangular pyramid) in at least a portion of scene to be rendered in a tile, a viewpoint within at least a portion of a scene to be rendered in a tile, or both that represent a portion of viewport 436 within a respective tile.

At step 620, to determine which graphics objects to rasterize in a tile, each graphics core 232 assigned to a tile is configured to perform one or more frustum queries on an acceleration structure 128, 300 using a corresponding frustum 442 associated with that tile (e.g., generated from the portion of viewport 436 in that tile). For example, each graphics core 232 assigned to a tile is configured to determine which graphics objects as represented by one or more nodes of a hierarchical level of an acceleration structure 128, 300 are wholly within a corresponding frustum 442 of the tile, at least partially within a corresponding frustum, 442 of the tile, intersect with a plane of the frustum 442 of the tile, or any combination thereof. According to some embodiments, two or more graphics cores 232 are configured to concurrently perform frustum queries to determine which graphics objects to rasterize in respective tiles. At step 625, based on one or more frustum queries performed by a respective graphics core 232, each graphics core 232 is configured to generate a respective list of graphics objects 444. Such a list of graphics objects 444 generated by a graphics core 232 assigned to a tile includes data indicating one or more graphics objects that are wholly within the corresponding frustum 442 of the tile, at least partially within the corresponding frustum 442 of the tile, intersect with a plane of the corresponding frustum 442 of the tile, or any combination thereof. At step 630, based on a respective list of graphics objects 444, each graphics core 232 is configured to rasterize one or more graphics objects in a respective tile. For example, a graphics core 232 is configured to rasterize each graphics object indicated in a respective list of graphics objects 444 generated by the graphics core 232.

In embodiments, the apparatus and techniques described above are implemented in a system including one or more integrated circuit (IC) devices (also referred to as integrated circuit packages or microchips), such as the APU described above with reference to FIGS. 1-6. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer-readable storage medium accessible to the computing system. Likewise, the code representative of one or more phases of the design or fabrication of an IC device may be stored in and accessed from the same computer-readable storage medium or a different computer-readable storage medium.

A computer-readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid state storage devices such as Flash memory, a cache, random access memory (RAM) or other non-volatile memory device or devices, and the like. The executable instructions stored on the non-transitory computer-readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
based on a frustum associated with a tile of a display space, performing a frustum query on at least a portion of an acceleration structure indicating a graphics object in the tile, wherein the frustum query indicates a position of at least a portion of the graphics object relative to the frustum; and
rasterizing the graphics object in the tile of the display space based on the frustum query.

2. The method of claim 1, further comprising:
generating a list of graphics objects in the tile based on the frustum query, wherein rasterizing the graphics object in the tile of the display space is based on the list of graphics objects.

3. The method of claim 1, further comprising:
based on the frustum associated with the tile of the display space, performing a second frustum query on a least a portion of the acceleration structure indicating a portion of the graphics object in the tile; and
performing a draw call for the portion of the graphics object in the tile based on the second frustum query.

4. The method of claim 3, further comprising:
generating a list of portions of graphics objects in the tile based on the second frustum query, wherein performing a draw call for the portion of the graphics object in the tile is based on the list of portions of graphics objects in the tile.

5. The method of claim 1, further comprising:
generating the frustum associated with the tile of the display space based on a viewport of a scene to be rendered.

6. The method of claim 5, wherein the frustum associated with the tile of the display space comprises a portion of the viewport in the tile.

7. The method of claim 1, further comprising:
based on a second frustum associated with a second tile of the display space, performing a second frustum query on at least a portion of an acceleration structure indicating a second graphics object in the second tile; and
rasterizing the second graphics object in the second tile of the display space based on the second frustum query.

8. A processor, comprising:
a graphics core associated with a first tile of a display space and configured to:
based on a frustum associated with the first tile of the display space, perform a frustum query on at least a portion of an acceleration structure indicating a graphics object in the first tile, wherein the frustum query indicates a position of at least a portion of the graphics object relative to the frustum; and
rasterize the graphics object in the first tile of the display space based on the frustum query.

9. The processor of claim 8, wherein the graphics core is configured to:
generate a list of graphics objects in the first tile based on the frustum query, wherein rasterizing the graphics object in the first tile of the display space is based on the list of graphics objects.

10. The processor of claim 8, wherein the graphics core is configured to:
based on the frustum associated with the first tile of the display space, perform a second frustum query on a least a portion of the acceleration structure indicating a portion of the graphics object in the first tile; and
perform a draw call for the portion of the graphics object in the first tile based on the second frustum query.

11. The processor of claim 10, wherein the graphics core is configured to:
generate a list of portions of graphics objects in the first tile based on the second frustum query, wherein performing a draw call for the portion of the graphics object in the first tile is based on the list of portions of graphics objects in the first tile.

12. The processor of claim 8, configured to:
generate the frustum associated with the first tile of the display space based on a viewport of a scene to be rendered.

13. The processor of claim 12, wherein the frustum associated with the first tile of the display space comprises a portion of the viewport in the first tile.

14. The processor of claim 8, further comprising:
a second graphics core configured to:
based on a second frustum associated with a second tile of the display space, perform a second frustum query on at least a portion of an acceleration structure indicating a second graphics object in the second tile; and
rasterize the second graphics object in the second tile of the display space based on the second frustum query.

15. The processor of claim 14, wherein the graphics core is configured to rasterize the graphics object in the first tile concurrently with the second graphics core rasterizing the second graphics object in the second tile.

16. A processor, comprising:
a plurality of graphics cores each associated with a respective tile of a display space and each configured to:
based on a corresponding frustum associated with the respective tile of the display space, perform a frustum query on at least a portion of an acceleration structure indicating a graphics object in the respective tile, wherein the frustum query indicates a position of at least a portion of the graphics object relative to the corresponding frustum; and
rasterize the graphics object in the respective tile of the display space based on the frustum query.

17. The processor of claim 16, wherein each graphics core is configured to:
generate a list of graphics objects in the respective tile based on the frustum query, wherein rasterizing the graphics object in the respective tile of the display space is further based on the list of graphics objects.

18. The processor of claim 16, wherein each graphics core is configured to:
based on the corresponding frustum associated with the respective tile of the display space, perform a second frustum query on a least a portion of the acceleration structure indicating a portion of the graphics object in the respective tile; and
perform a draw call for the portion of the graphics object in the respective tile based on the second frustum query.

19. The processor of claim 18, wherein each graphics core is configured to:
generate a list of portions of graphics objects in the respective tile based on the second frustum query, wherein performing a draw call for the portion of the graphics object in the respective tile is based on the list of portions of graphics objects in the respective tile.

20. The processor of claim 16, wherein each corresponding frustum represents a portion of a viewport in a respective tile.
